(19) United States
(12) Patent Application Publication
(10) Pub. No.: US 2008/0258687 A1
(43) Pub. Date: Oct. 23, 2008

(54) High Efficiency PWM Switching Mode with High Accuracy Linear Mode Li-Ion Battery Charger

(75) Inventors: John S.K. So, Fremont, CA (US); Kevin D'Angelo, Fremont, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Sunnyvale, CA (US)

(21) Appl. No.: 11/736,405

(22) Filed: Apr. 17, 2007

(51) Int. Cl. H02J 7/00

(52) U.S. Cl. 320/145

(57) ABSTRACT

A battery charger includes: a step-down switching converter connected to provide power at a predetermined average current from an input voltage V+ to an output node V_{OUT}; a regulating switch connected to provide power at a predetermined voltage from the input node V+ to the output node V_{OUT}; a mixed mode control circuit configured to charge a battery connected to the output node V_{OUT} in a predetermined sequence that includes: a preconditioning phase where the regulating switch provides power to the battery; and a constant current phase where the switching converter delivers power to the battery.

### BACKGROUND OF THE INVENTION

As more and more features are integrated into handheld devices and portable electronic systems such as cellular phones, personal digital/data assistants (PDAs), digital cameras, portable video players and other handheld equipment, the power consumption of these devices will increase. The demand for higher battery capacity is in turn increased to maintain a reasonable run time for each device. The Lithium-ion battery currently is the battery of preference for most of the handheld devices and portable electronic systems with rechargeable batteries because of its higher packing power density.

To charge a Lithium-ion battery, up to three charging modes are applied depending on the open terminal voltage of the battery before it is recharged. For a deeply discharged cell, a preconditioning current of approximately 10% of the maximum charge current is first applied to slowly charge the cell up to a level where it can accept the maximum charge current. If the cell is not as deeply discharged and its voltage is already above this threshold, then the maximum charge current is applied and the preconditioning current is not required. The maximum charging current is applied until the battery voltage reaches its regulated voltage level threshold. Once the regulated voltage threshold has been detected, the charger regulates the battery voltage until the charge current drops to approximately 10% of the maximum charge current, stops charging, and the charge is complete (see FIG. 1).

Programmed charging current is proportional to battery capacity. Battery capacity is rated by C; or measured by mAh (mA Hour). A 300 mAh cell can provide a load current of 300 mA for an hour; or 150 mA of load current for 2 hours. The C-rating of a battery cell is defined as the rated capacity of the cell expressed in mA. For example: A 500 mAh battery has a C-rating of 500 mA. 1C charging of this battery means the charging current is 500 mA.

There are two types of chargers currently employed in the industry for Li-ion battery charging. They are known as the linear mode charger (FIG. 2) and the switching mode charger (FIG. 3). The linear mode charger has widely been used because of its simplicity and low system cost. Accuracy of +/−1% EOC (End of Charge) voltage over operational temperatures required by various Li-ion battery manufacturers is easy to meet with the linear mode charger. The linear battery charger may be simple, but as batteries increase in size and charging currents increase, power dissipation becomes a problem. The switch mode charger is the alternative solution because of its efficiency. Typically, the linear charger will reach its power dissipation limit with approximately 1 amp of charging current at a moderate input to output voltage differential. On the other hand, the high efficiency of the switch mode charger can extend the charging current beyond 2 amps even with a high input to output voltage differential. Like the linear charger, the switch mode charger has its drawbacks. Besides system cost due to the required inductor, the switch mode charger suffers inaccurate low level current regulation caused by ripple current, input/output impedance mismatch induced oscillation tendencies, hot plug inductance induced voltage spiking and light load current induced electromagnetic noise generation.

### SUMMARY OF THE INVENTION

The present invention includes a Li-ion battery charger design that combines the linear mode charger and the switch mode charger in the same charger system (FIG. 4). The new charger system takes advantage of the best of each charger type capability. In the battery conditioning mode where a low current level is required, a linear battery charger is employed. Likewise, during voltage mode and end of charge, where accurate current and voltage regulation is required, a linear battery charger is employed. But when high current and high efficiency is required, the switch mode battery charger is employed (FIG. 5). Thus the problem areas of each type of charger are eliminated.

### BRIEF DESCRIPTION OF THE DRAWINGS

FIG. 1 shows a charging profile representative of the output of a typical prior art Li-ion battery charger.

FIG. 2 is a block diagram of a prior art linear mode charger.

FIG. 3 is a block diagram of a prior art switching mode charger.

FIG. 4 is a block diagram of an embodiment of the mixed mode charger provided by the present invention.

FIG. 5 shows a charging profile representative of the output of the mixed mode charger provided by the present invention.

FIG. 6 is a block diagram of an embodiment of the mixed mode charger that uses the high side switch to perform linear charging.

FIG. 7 is a block diagram of an embodiment of the mixed mode charger that uses the high side switch to perform linear charging and includes an additional higher impedance switch to bypass the inductor.

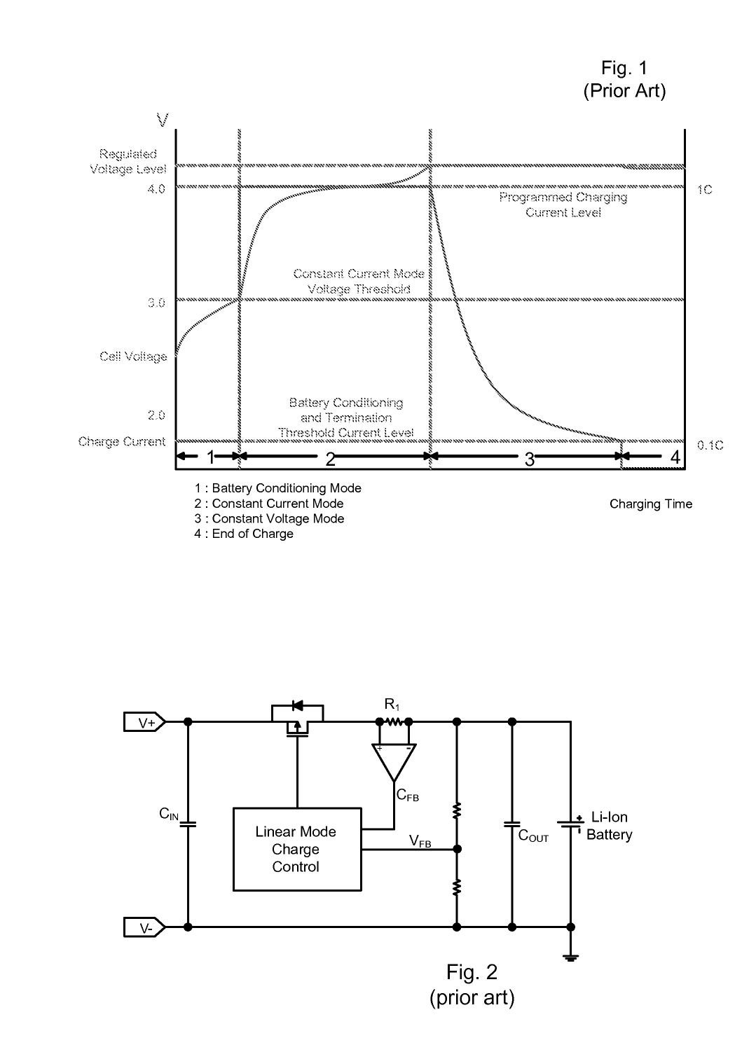

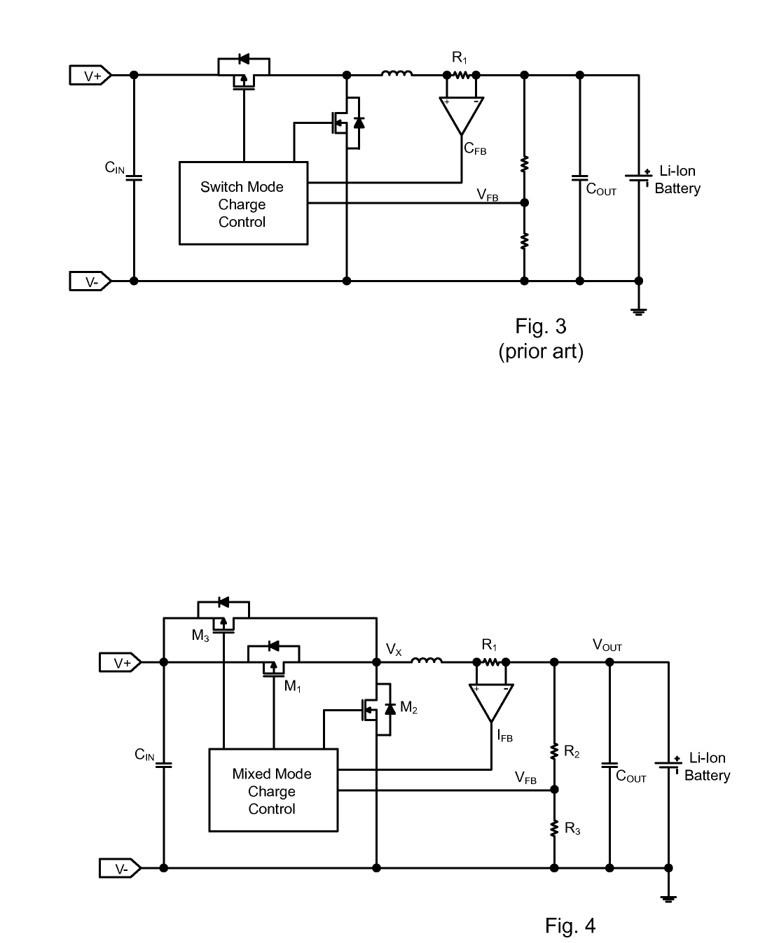

### DETAILED DESCRIPTION OF THE PREFERRED EMBODIMENTS

The present invention provides a mixed-mode charger for Li-ion batteries. The mixed mode charger includes a step-down switching converter and a linear regulator. A mixed mode control circuit controls the step-down switching converter and the linear regulator in a predetermined sequence that includes:
1) a battery conditioning phase where the linear regulator delivers power to a battery being charged at a predetermined low current level,
2) a constant current mode where the step-down switching converter delivers power to the battery at a predetermined average current;
3) a first constant voltage mode where the step-down switching converter delivers power to the battery at a predetermined voltage;
4) a second constant voltage mode where the linear regulator delivers power to the battery at a predetermined voltage;
5) a battery maintenance mode where the linear regulator delivers power to the battery at a predetermined voltage.

During this sequence, the linear regulator is used where low current levels are sufficient. The step-down converter is used where more current is required. This maximizes efficiency and accuracy throughout the charging sequence.

FIG. 4 shows a first embodiment (labeled 400) of the mixed mode battery charger. As shown in FIG. 4, mixed mode battery charger has inputs for a positive voltage (V+) and a negative voltage (V−). Negative input voltage V− may also be ground. The output of the mixed mode battery charger 400 is represented by a Li-ion battery connected between an output node V_{OUT} and the negative input voltage (V−).

The step-down converter within charger 400 includes a high-side switch M₁ connected between the positive input voltage (V+ in this case) and a node V_{X}. A low-side switch M₂ is connected between the node V_{X} and the negative input voltage (V− in this case). An inductor L is connected between the node V_{X} and the output node (V_{OUT}) of the converter. Two filtering capacitors and V_{OUT} are included. The first (C_{IN}) is connected on the input side of charger 400 between the positive input voltage V+ and negative input voltage V−. The second (C_{OUT}) is connected on the output side of charger 400 between the output node V_{OUT} and the negative input voltage V−.

The linear regulator portion of mixed mode battery charger includes a current regulating transistor M₃. Current regulating transistor M₃ is connected in parallel with high-side switch M₁.

Mixed mode charger 400 includes two feedback circuits. The first or current feedback circuit includes a current sense resistor R₁. An amplifier 402 is connected over the current sense resistor R₁ to generate a feedback signal I_{FB} that is proportional to the current following through the current sense resistor R₁. In this way I_{FB} indicates the amount of current that is being supplied to the Li-ion battery. The second feedback circuit generates a voltage V_{FB} that is proportional to the voltage over the Li-ion battery. For the particular implementation being described, V_{FB} is generated by a resistor divider including R₂ and R₃ connected between the output node V_{OUT} and the negative input voltage V−.

Mixed mode battery charger 400 also includes a mixed mode control circuit 404 connected to receive the two feedback signals I_{FB} and V_{FB}. Mixed mode control circuit 404 is also connected to control high-side switch M₁, low-side switch M₂ and current regulating transistor M₃. This allows mixed mode control circuit 404 to choose between a switching mode, where mixed mode battery charger operates as a step-down switching converter and a linear mode where mixed mode control circuit 404 operates as a linear regulator.

During switching mode operation, mixed mode control circuit 404 turns switch M₁ ON and OFF in a repeating pattern. Switch M₂ is controlled to be out of phase with switch M₁ so that M₂ is OFF when M₁ in ON and vice-versa. As is well known, the basic out-of-phase switching pattern is preferably modified so that the switch being turned OFF is turned OFF before the switch being turned ON is turned ON. This is known as break-before-make and prevents both switches (M₁ and M₂) from being ON simultaneously creating a path from the positive input voltage (V+) to the negative input voltage (V−).

Each time M₁ is turned on the inductor L is connected between the positive input voltage (V+) and the output node V_{OUT}. This causes current to flow from the positive input voltage (V+), through the inductor L to the load (i.e., the Li-ion battery). In the process, energy is stored in the inductor L in the form of a magnetic field. M₁ is then turned OFF and M₂ is turned ON. When this happens, the inductor L is connected between the negative input voltage (V−) and the load. In this phase, current supplied by the magnetic field of the inductor flows to the output node V_{OUT} and the load. The switching cycle then repeated to deliver a constant stream of current pulses to the Li-ion battery.

During switching mode, the mixed mode control circuit 404 monitors the current feedback signal I_{FB} to control the average rate at which current is delivered to the Li-ion battery. This type of control, known as average current control, is achieved by varying the amount of time that the switch M₁ remains ON relative to the amount of time switch M₂ remains ON. This is done using two different methods. In the first method, the switching frequency of the switches M₁ and M₂ is varied. This is known as pulse frequency modulation or PFM. In the second method a fixed switching frequency is used and the amount of time that the switch M₁ is turned ON is varied. This is known as pulse width modulation or PWM.

For linear mode operation, mixed mode control circuit 404 maintains switch M₁ and M₂ OFF. At the same time, mixed mode control circuit 404 controls the gate drive to switch M3 as a function of the voltage feedback signal V_{FB}. This allows mixed mode control circuit 404 to supply power to the Li-ion battery at a predetermined constant voltage.

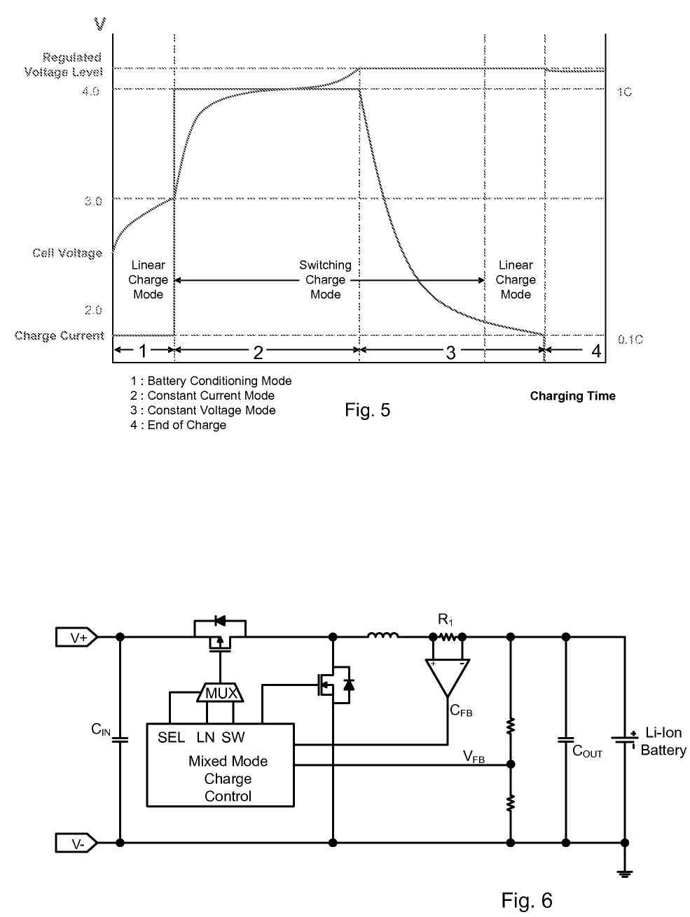

As shown in FIG. 5, a typical charging sequence for a Li-ion battery includes the following phases: 1) battery conditioning, 2) constant current, 3) constant voltage and, 4) end of charge. Mixed mode control circuit 404 selects linear mode operation for the battery conditioning and end of charge phases. Linear mode operation is also used for the final portion of the constant voltage phases where the current being supplied to the Li-ion battery is relatively low. For the remaining portion of the constant voltage phase and for the constant current phase, mixed mode control circuit 404 selects switching mode operation. This allows mixed mode battery charger 400 to efficiently provide greater amounts of current to the Li-ion battery.

Turning now to FIG. 6, a second embodiment for a mixed mode battery charger is shown and labeled 600. Mixed mode battery charger 600 previously described for mixed mode battery charger 400. In this case, however, switch M₃ and switch M₁ are combined. A single switch (labeled M₁) is used to provide control during the linear mode of operation and switching during the switching mode of operation. This is accomplished using a MUX that connects the gate of the switch M₁ to two different signals. The first signal, labeled SW is a digital signal used to drive M₁ ON and OFF during switch mode operation. The second signal labeled LN is an analog LN signal used to vary the gain of M₁ during linear mode operation. The LN and SW signals are equivalent to the drives supplied to switch M₃ and M₁ (respectively) in the embodiment of FIG. 4.

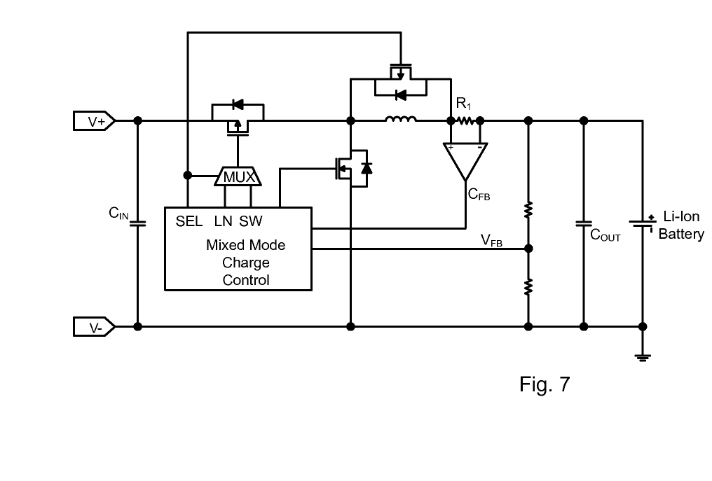

As shown in FIG. 7, a third embodiment for a mixed mode battery charger 700 includes the components just described for mixed mode battery charger 600. In this case, however, an additional switch M₄ is included to allow inductor L to be bypassed during linear mode operation. Thus, switch M₄ is activated by mixed mode control circuit 404 whenever battery charger 700 is operating in linear mode. Switch M₄ may also be added to the embodiment shown in FIG. 4.

In general, it should be appreciated that the embodiments shown in the preceding figures have a range of equivalents. For example, as is well known in the art, the low-side switch M₂ may be replaced with a Schottky diode (or other diode type). This transforms the step-down switching converter from a synchronous type to an asynchronous type. Different types of control schemes may also be applied to the high-side switch and low-side switching including different types of PFM or pulse skipping.

What is claimed is:

1. A battery charger that includes:
a step-down switching converter connected to provide power at a predetermined average current from an input voltage V+ to an output node V_{OUT};
a regulating switch connected to provide power at a predetermined voltage from the input node V+ to the output node V_{OUT};
a mixed mode control circuit configured to charge a battery connected to the output node V_{OUT} in a predetermined sequence that includes:
a preconditioning phase where the regulating switch provides power to the battery; and
a constant current phase where the switching converter delivers power to the battery.

2. A battery charger as recited in claim 1 where the predetermined sequence includes:
a first constant voltage phase where the switching converter delivers power to the battery; and
a second constant voltage phase where the regulating switch provides power to the battery.

3. A battery charger as recited in claim 1 where the step down switching converter includes:
a high-side switch connected between an input node V+ and a node V_{X};
a low-side switch connected between the node V_{X} and ground; and
an inductor connected in series between the node V_{X} and the output node V_{OUT}.

4. A battery charger as recited in claim 2 that further comprises a switch connected in parallel with the inductor to bypass the inductor when the regulating switch provides power to the battery.

5. A battery charger as recited in claim 2 that further comprises a switch connected in parallel with the inductor to bypass the inductor when the regulating switch provides power to the battery.

6. A method for charging a battery that includes:
activating a regulating switch during a preconditioning phase to provide power at a predetermined voltage from the input node V+ to an output node V_{OUT};
activating a step-down switching converter during a constant current phase to provide power at a predetermined average current from an input voltage V+ to an output node V_{OUT};

7. A battery charger as recited in claim 1 where the predetermined sequence includes:
a first constant voltage phase where the switching converter delivers power to the battery; and
a second constant voltage phase where the regulating switch provides power to the battery.

8. A battery charger as recited in claim 1 where the step down switching converter includes:
a high-side switch connected between an input node V+ and a node V_{X};
a low-side switch connected between the node V_{X} and ground; and
an inductor connected in series between the node V_{X} and the output node V_{OUT}.

9. A battery charger as recited in claim 2 that further comprises a switch connected in parallel with the inductor to bypass the inductor when the regulating switch provides power to the battery.

10. A battery charger as recited in claim 2 that further comprises a switch connected in parallel with the inductor to bypass the inductor when the regulating switch provides power to the battery.
